(19) United States
(12) Patent Application Publication
(10) Pub. No.: US 2004/0024650 A1
(43) Pub. Date: Feb. 5, 2004

(54) Mobile take-out goods transaction system and its method

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314

(73) Assignee: Sin Etke Technology Co., Ltd., Taipei City (TW)

(21) Appl. No.: 10/244,742

(22) Filed: Sep. 17, 2002

(30) Foreign Application Priority Data
Jul. 31, 2002 (TW) 91117111

(51) Int. Cl. G06F 17/60

(52) U.S. Cl. 705/26

(57) ABSTRACT

A mobile take-out goods transaction system is disclosed, which uses a wireless ordering device on board to order goods wirelessly from a specific store through a customer service center, which customer service center in turns transmits the order data containing the personal identification number (PIN) of the motor vehicle owner to a specific store, enabling the specific store to prepare the ordered merchandise in advance, so that the motor vehicle can order when driving and then the car directly drive to the unique outlet counter of the specific store next to the side of a street to pick up the ordered merchandise without wasting time, and saving the purchase lane investment cost.

### BACKGROUND OF THE INVENTION

1. Field of the Invention

The present invention relates to a take-out goods transaction method and, more particularly, to a mobile take-out goods transaction system adapted for ordering take-out goods when driving a car. The invention relates also to the method of running the mobile take-out goods transaction system.

2. Description of Related Art

FIG. 1 is a schematic drawing explaining the conventional mobile take-out goods transaction procedure. As illustrated, the store T providing a driver's purchase lane R3 and having an ordering counter C4 and an outlet counter C5 is by a side of the main street R2. The store T provides a service allowing drivers to line up and to purchase supplied items without getting off the car (like McDonald's Drive-thru).

However, due to high land cost, it requires a big invest to provide the aforesaid driver's purchase lane in cities. The hiring of the employees to handle the ordering counter and the outlet counter also greatly increases personal expense. Further, when many drivers drove in the driver's purchase lane at the same time, it may cause traffic jam. After having taken the ordered take-out items from the outlet counter C5, the driver may have to wait for a certain length of timer before driving the car into the main street R2.

Therefore, it is desirable to provide a mobile take-out goods transaction system that eliminates the aforesaid problems.

### SUMMARY OF THE INVENTION

It is the main object of the present invention to provide a mobile take-out goods transaction system that enables the owner to order goods by radio when driving the car, and then to drive the car directly to a roadside outlet counter to take the ordered goods without wasting time. It is another object of the present invention to provide a mobile take-out goods transaction system that helps stores save much owner's purchase lane investment cost and the related personal expense. It is still another object of the present invention to provide a mobile take-out goods transaction method, which uses a customer service center to gather merchandise information from specific stores for car owners for ordering reference, so that the customer service center obtains a brokerage from the owners and the stores to maintain the running of the business.

To achieve these and other objects and according to one aspect of the present invention, the mobile take-out goods transaction system comprises at least one store-end computer respectively installed in a respective store allocated by a side of a street and selling at least one merchandise and having a unique outlet counter next to the side of the street, the at least one store each defining a store code; a plurality of on-vehicle wireless ordering devices respectively installed in a respective motor vehicle and adapted for sending out an order data wirelessly, the order data containing at least a PIN number of the owner of the motor vehicle and a list of ordered merchandise, the list of ordered merchandise containing item name and/or item number and quantity of merchandise to be ordered from a specific store which is one of the stores and sells the ordered merchandise; and a customer service center server connected to the at least one store-end computer and adapted for receiving the order data wirelessly from the on-vehicle wireless ordering devices and transmitting the order data to a specific store-end computer corresponding to the specific store, for enabling the specific store to prepare in advance the goods listed in the list of ordered merchandise of the order data and to correspond the prepared goods to the PIN number of the owner of the motor vehicle, so that the owner of the motor vehicle can drive directly to the unique outlet counter of the specific store to pick up the goods corresponding to the PIN number of the owner of the motor vehicle.

According to another aspect of the present invention, the mobile take-out goods transaction method comprises the steps of: (a) using an on-vehicle wireless ordering device to send out an order data to a customer service center, the on-vehicle wireless ordering device being installed in a motor vehicle, the customer service center being connected to at least one store, the store each defining a store code, the order data containing at least a PIN number of the owner of the motor vehicle and a list of ordered merchandise, the list of ordered merchandise containing item name and/or item number and quantity of merchandise to be ordered from a specific store which is one of the stores and sells the ordered merchandise; (b) the customer service center transmitting the order data to the specific store, the specific store being allocated by a side of a street and selling at least one merchandise and having a unique outlet counter next to the side of the street; (c) the specific store preparing goods subject to the list of ordered merchandise of the order data and corresponding the prepared goods to the PIN number of the owner of the motor vehicle; and (d) the owner of the motor vehicle driving directly to the unique outlet counter of the specific store to pick up the ordered merchandise corresponding to the PIN number of the owner of the motor vehicle.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing explaining the conventional mobile take-out goods transaction procedure.

FIG. 2 is a schematic drawing showing the system architecture of a mobile take-out goods transaction system according to the first embodiment of the present invention.

FIG. 3 is a flow chart of the first embodiment of the present invention.

FIG. 4 is a schematic drawing showing an order data according to the first embodiment of the present invention.

FIG. 5 is a schematic drawing showing the system architecture of a mobile take-out goods transaction system according to the second embodiment of the present invention.

FIG. 6 is a flow chart of the second embodiment of the present invention.

FIG. 7 is a schematic drawing showing an order data containing store locations according to the second embodiment of the present invention.

### DETAILED DESCRIPTION OF THE PREFERRED EMBODIMENT

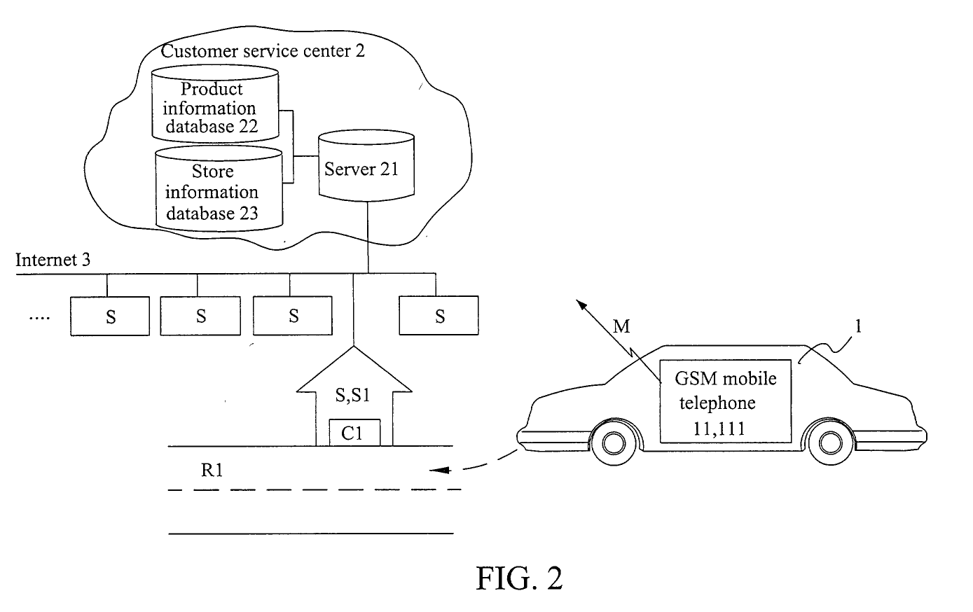

FIG. 2 is a schematic drawing showing the system architecture of a mobile take-out goods transaction system according to the first embodiment of the present invention. As illustrated, store-end computers S are connected to the server 21 of a customer service center 2 through the Internet 3. The store-end computers S are respectively installed in stores that sell different goods. The customer service center 2 further comprises a merchandise database 22, which gathers and stores information of merchandise provided by the stores, and a store database 23, which stores basic information of stores including names of merchandise, merchandise item numbers, store code, and etc. The server 21 is capable of transmitting the aforesaid merchandise information and basic information of stores to an on-vehicle wireless ordering device 11 installed in a motor vehicle 1 by radio for ordering reference. According to this embodiment, the on-vehicle wireless ordering device 11 is a GSM mobile telephone 111. The stores according to the present invention are preferably but not necessarily chain stores, for example, McDonald's, Pizza Hut, Seven-Eleven, or the like.

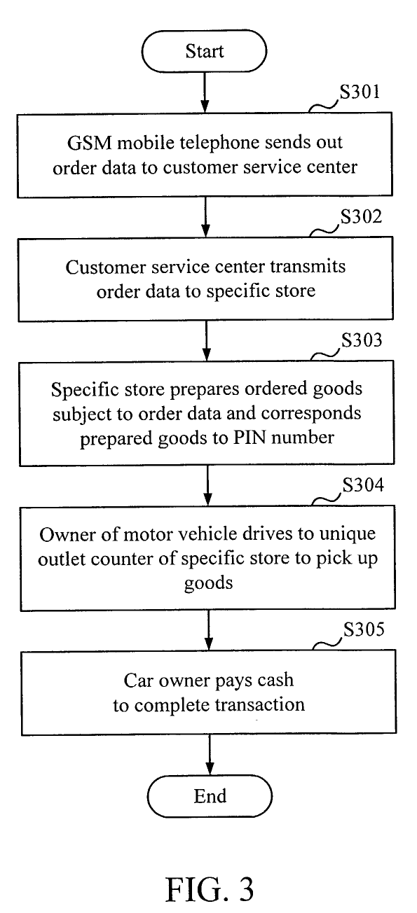

With reference to FIG. 3 and FIG. 2, when driving the motor vehicle 1, the owner can use the GSM mobile telephone 111 in the motor vehicle 1 to send out an order data M to the customer service center 2 by radio (Step S301). The order data M includes the access number of the GSM mobile telephone 111 (for use as the PIN number of the owner), the list of ordered merchandise L, and the code S1 of the specific store. A GPRS mobile telephone, pager, or any of a variety of radio communication apparatus installable in a motor vehicle may be used instead of the GSM mobile telephone 111. Further, the car number, engine number, owner's credit card number, owner's identification number, member code number obtained from the customer service center 2, or any identification code number of the owner may be used to substitute for the access number of the GSM mobile telephone.

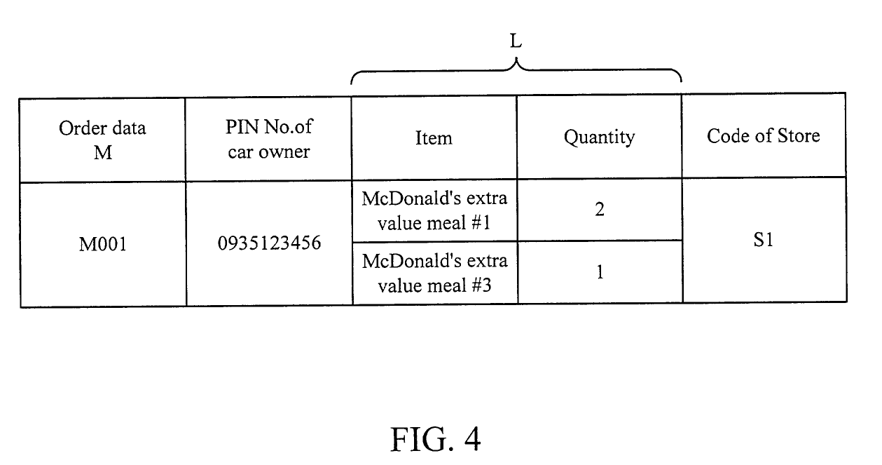

Referring to FIG. 4, according to the aforesaid list of ordered merchandise L, the owner ordered two McDonald's Extra Value Meal #1 and one McDonald's Extra Value Meal #3; the access number of the GSM mobile telephone 111 is “0935123456”; the store code of the specific store is S1. The list of ordered merchandise L, the access number of the GSM mobile telephone 111 and the store code S1 form an order data “M001”. The content of the order data M is subject to the items and quantity the owner ordered.

Referring to FIGS. 2 and 3 again, when the server 21 received the order data “M001” by radio, it immediately transmits the information to the store-end computer S1 of the specific store assigned by the owner (Step S302) through the Internet 3. The specific store prepares the meals in advance subject to the order data “M001”, and adheres a label to the package of ordered meals corresponding to the access number “0935123456” of the GSM mobile telephone number (Step S303), for assuring accurate delivery of the package of ordered meals to the owner. The server 21 may use a local area network or radio communication apparatus to transmit the order data “MOOL” to the store-end computer SI of the specific store instead of the Internet 3.

When the ordering procedure was done, the motor vehicle owner can then drive directly to the unique outlet counter C1 of the specific store next to the side of the main street R1 to pick up the package of ordered meals corresponding to the access number of the GSM mobile telephone “0934123456” (Step S304), and to pay cash to the serviceman so as to complete the transaction (Step S305).

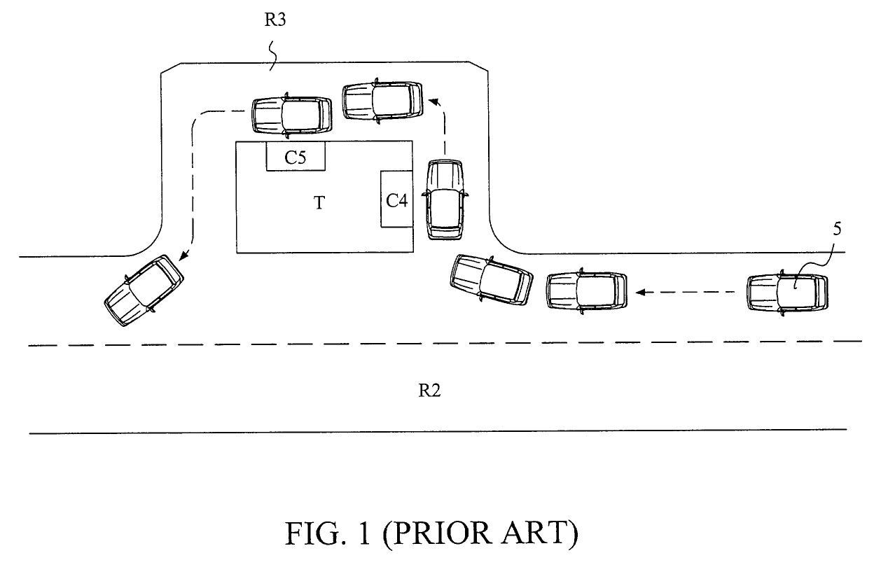

According to this embodiment, the store needs only to set up one, i.e., the unique one outlet counter next to the side of the main street without establishing an owner's purchase lane R3 and an ordering counter C4 (see FIG. 1). Therefore, the invention saves much land cost and personal expense.

Further, because the owner can order goods from specific stores by radio through the customer service center, the owner needs not to line up at the ordering counter C4 and to give the order to the serviceman. Therefore, the transaction time is greatly shortened.

The merchandise database 22 of the customer service center 2 has stored therein merchandise information of related stores sell as well as related promotional information. The server 21 can send the stored information from the merchandise database 22 to the owner by radio or broadcasting. Therefore, the invention enables motor vehicle owners to purchase goods conveniently, and bring business chances to stores. Therefore, the customer service center 2 can collect a brokerage from motor vehicle owners and stores to maintain normal running of the business, i.e., the invention is beneficial to motor vehicle owners, stores, as well as the customer service center, and all parties are the winner.

In the aforesaid transaction, the owner can pay the money by a credit card through the server 21 before picking up the order, by post office remittance after picked up the order, or by a credit card when picking up the order subject to the payment system of respective stores or the services provided by the customer service center 2.

When the car number is used as the identification code number of the owner, the specific store can install a video camera (for example, a charge-coupled device type video camera) in front of the outlet counter C1 to detect the car number of the approaching car for recognition. Therefore, when the owner arrived the outlet counter C1, the store-end computer S1 automatically identifies the number of the approached car and informs the serviceman to provide the ordered goods. Of course, the motor vehicle owner can dial the GSM mobile telephone 111 to the customer service center 2 or uses the GSM mobile telephone 111 to send a short message to the customer service center 2 before arriving the outlet counter C1. After recognition of the PIN number of the motor vehicle owner by the customer service center 2, the customer service center 2 sends a message to inform the store-end computer S1 of the specific store of the arriving of the client so that the serviceman of the specific store can prepare goods in advance, saving waiting time. The motor vehicle owner can also directly dial the GSM mobile telephone 111 to the specific store before arriving the outlet counter C1, enabling the serviceman of the specific store to recognize his (her) PIN number in advance.

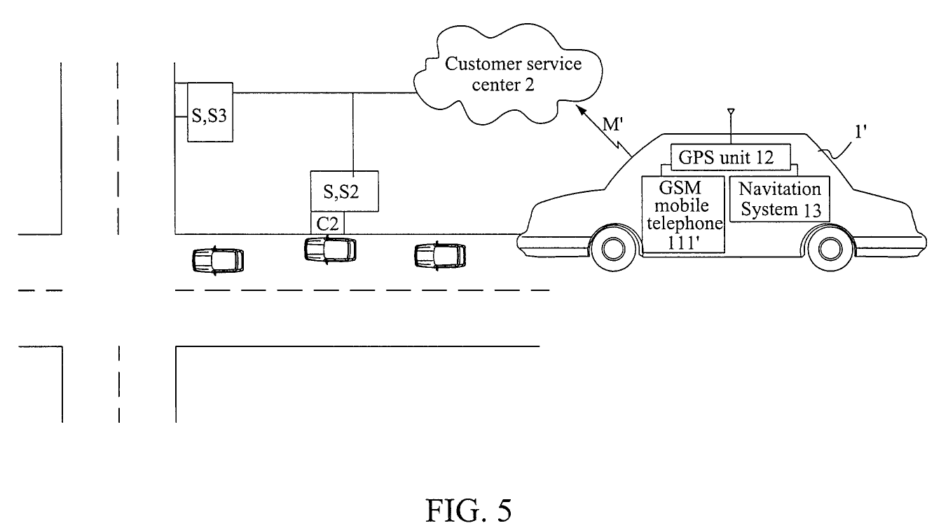

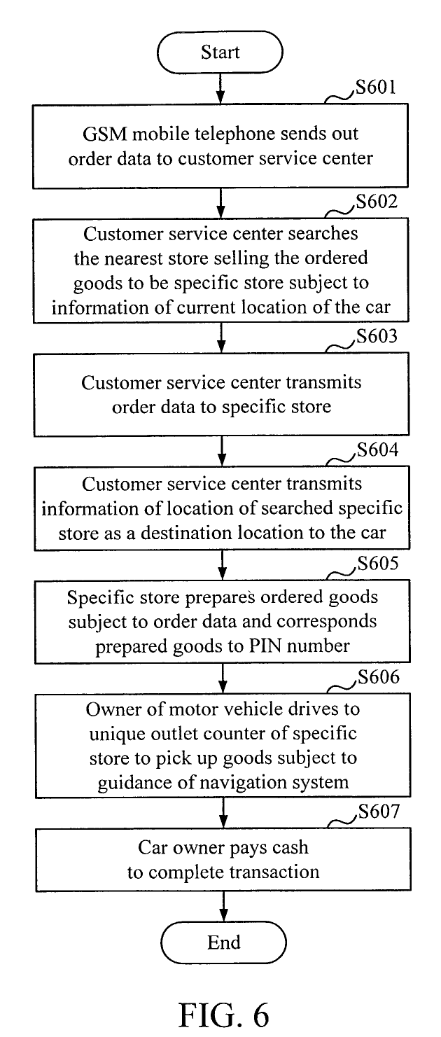

FIGS. 5 and 6 show the second embodiment of the present invention. This embodiment is substantially similar to the aforesaid first embodiment of the present invention with the exception of the additional GPS (global positioning system) unit 12 and navigation system 13 in the motor vehicle 1′. Further, the order data M′ transmitted through the GSM mobile telephone 111′ needs not to mention the specific store.

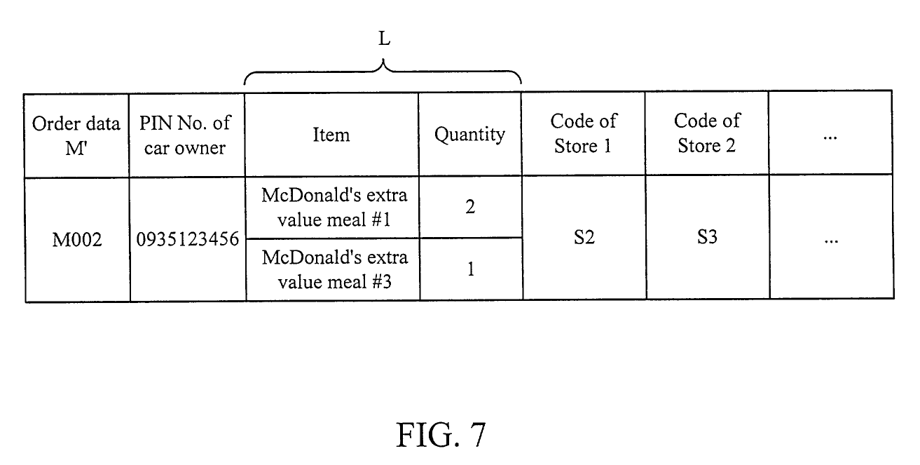

Therefore, when ordering goods through the customer service center 2 (Step S601) the order data M′ sent through the GSM mobile telephone 111′ contains the information of the current location of the motor vehicle 1′ calculated by the GPS unit 12. Because the owner ordered two McDonald's Extra Value Meal #1 and one McDonald's Extra Value Meal #3, the customer service center 2 searches the nearest McDonald's store subject to the information of the current location of the motor vehicle 1′ (Step S602), or a number of McDonald's stores close to the current location of the motor vehicle 1′ for the owner to select. As illustrated in FIG. 5, the store-end computers S2 and S3 are installed in different McDonald's stores. The customer service center 2 suggests the order data “M002” as shown in FIG. 7 and transmits the information to the motor vehicle 1′. The customer service center 2 transmits the order data “M002” to the store-end computer S2 of the searched specific store only after the owner selected the store code “S2” (Step S603).

When wishing to order goods, the owner can input the name of the store (For example, input “McDonald's”) to search qualified stores, or the kind of merchandise (for example, input “Pizza”) to search qualified store information (such as Pizza Hut, Domino, . . . and etc.).

In order to let the owner obtain the goods ordered within the shortest time, the motor vehicle 1′ is equipped with a navigation system 13, and the customer service center 2 will transmit the location information of the specific store as a destination location to the navigation system 13 (Step S604), enabling the navigation system 13 to search the best route between the current location of the motor vehicle 1′ and the specific store for reference. At this time, the specific store can prepare the ordered meals in advance subject to the order data M′ (Step S605). Subject to the guidance of the navigation system 13, the owner directly drives the motor vehicle 1′ to the outlet counter C2 along the main street to pick up the ordered meals (Step S606).

Further, because the motor vehicle 1′ according to this embodiment is equipped with a GPS unit 12, it is workable to continuously monitor the location of the motor vehicle 1′ and judge the distance between the motor vehicle 1′ and the specific store through the GPS unit 12. Therefore, when the distance between the motor vehicle 1′ and the specific store is shorter than a predetermined critical value, the GSM mobile telephone 111′ is automatically dialed to the customer service center 2 or specific store, enabling the serviceman of the specific store to prepare goods in advance. OF course, the motor vehicle owner can also actively dial up or send a short message to the customer service center 2 or specific store, informing the customer service center 2 or specific store the fact of going to arrive the outlet counter C2 shortly.

In the aforesaid two embodiments, the merchandise information provided by stores is preferably downloaded from the customer service center 2 to the motor vehicle wireless on the real time. Of course, the owner can dial to the customer service center 2, asking the serviceman to search the desired merchandise information and to order the desired goods. Preferably, the customer service center 2 regularly or irregularly issue or sell CD or memory card providing the latest merchandise information.

Although the present invention has been explained in relation to its preferred embodiments, it is to be understood that many other possible modifications and variations can be made without departing from the spirit and scope of the invention as hereinafter claimed.

What is claimed is:

1. A mobile take-out goods transaction system comprising:
at least one store-end computer respectively installed in a respective store allocated by a side of a street and selling at least one merchandise and having a unique outlet counter next to the side of said street, said store each defining a store code;
a plurality of on-vehicle wireless ordering devices respectively installed in a respective motor vehicle and adapted for sending out an order data wirelessly, said order data containing at least a PIN number of the owner of the motor vehicle and a list of ordered merchandise, said list of ordered merchandise containing item name and/or item number and quantity of merchandise to be ordered from a specific store which is one of said stores and sells said ordered merchandise; and
a customer service center server connected to said at least one store-end computer and adapted for receiving the order data wirelessly from said on-vehicle wireless ordering devices and transmitting the order data to a specific store-end computer corresponding to said specific store, for enabling the specific store to prepare in advance the goods listed in said list of ordered merchandise of the order data and to correspond the prepared goods to the PIN number of the owner of the motor vehicle, so that the owner of the motor vehicle can drive directly to said unique outlet counter of the specific store to pick up the goods corresponding to the PIN number of the owner of the motor vehicle.

2. The mobile take-out goods transaction system as claimed in claim 1, wherein said on-vehicle wireless ordering device is a GSM mobile telephone.

3. The mobile take-out goods transaction system as claimed in claim 2, wherein the PIN number is the access number of the GSM mobile telephone.

4. The mobile take-out goods transaction system as claimed in claim 1, wherein said stores include chain stores.

5. The mobile take-out goods transaction system as claimed in claim 1, wherein said customer service center server has stored therein merchandise information provided by every store, and is adapted to transmit said merchandise information wirelessly to said on-vehicle wireless ordering devices for ordering reference.

6. The mobile take-out goods transaction system as claimed in claim 1, wherein said order data contains a specific store code corresponding to the specific store, and said customer service center server is adapted to transmit said order data to the specific store-end computer corresponding to the specific store by referring said specific store code.

7. The mobile take-out goods transaction system as claimed in claim 1, wherein said customer service center server provides information of the location of each store; said motor vehicle further comprises a GPS (global positioning system) unit connected to said on-vehicle wireless order device for computing a current location of the motor vehicle, so that each of said on-vehicle wireless ordering device can transmit the current location of the motor vehicle to said customer service center server for enabling said customer service center server to compare the current location of the motor vehicle with the information of the location of each store and to search the nearest store selling the goods listed in said list of ordered merchandise to be the specific store.

8. The mobile take-out goods transaction system as claimed in claim 7, wherein said on-vehicle wireless ordering devices each further have a navigation system connected thereto and installed in the respective motor vehicle; said customer service center server is capable of transmitting the information of the location of the searched specific store wirelessly to the motor vehicle for guiding the owner of the motor vehicle driving directly to the searched specific store subject to the guidance of said navigation system using the information of the location of the searched specific store as a destination location.

9. The mobile take-out gods transaction system as claimed in claim 1, wherein said customer service center server transmits said order data to said store-end computers through a cable.

10. The mobile take-out goods transaction system as claimed in claim 9, wherein said customer service center server transmits said order data to said store-end computers through a wired network.

11. A mobile take-out goods transaction method comprising the steps of:
(a) using an on-vehicle wireless ordering device to send out an order data to a customer service center, said on-vehicle wireless ordering device being installed in a motor vehicle, said customer service center being connected to at least one store, said store each defining a store code, said order data containing at least a PIN number of the owner of the motor vehicle and a list of ordered merchandise, said list of ordered merchandise containing item name and/or item number and quantity of merchandise to be ordered from a specific store which is one of said stores and sells said ordered merchandise;
(b) said customer service center transmitting said order data to the specific store, said specific store being allocated by a side of a street and selling at least one merchandise and having a unique outlet counter next to the side of the street;
(c) the specific store preparing goods subject to said list of ordered merchandise of the order data and corresponding the prepared goods to the PIN number of the owner of the motor vehicle; and
(d) the owner of the motor vehicle driving directly to the unique outlet counter of the specific store to pick up the ordered merchandise corresponding to the PIN number of the owner of the motor vehicle.

12. The mobile take-out goods transaction method as claimed in claim 11, further comprising the step of (e) the owner of the motor vehicle paying the money to complete the transaction.

13. The mobile take-out goods transaction method as claimed in claim 11, wherein said on-vehicle wireless ordering device is a GSM mobile telephone.

14. The mobile take-out goods transaction method as claimed in claim 13, wherein the PIN number is the access number of the GSM mobile telephone.

15. The mobile take-out goods transaction method as claimed in claim 11, wherein said stores include a chain stores.

16. The mobile take-out goods transaction method as claimed in claim 11, where said order data of said step (a) further contains a specific store code corresponding to the specific store; said customer service center transmits said order data to the specific store by referring said specific store code during step (b).

17. The mobile take-out goods transaction method as claimed in claim 11, wherein the motor vehicle further comprises a GPS unit connected to said on-vehicle wireless ordering device for computing a current location of the motor vehicle; said customer service center provides the information of the location of each store; said on-vehicle wireless ordering devices transmits the current location of the motor vehicle to said customer service center server during said step (a); said step (b) further comprises a sub-step (b0) where said customer service center comparing the current location of the motor vehicle with the information of the location of each store and searching the nearest store selling the goods listed in said list of ordered merchandise to be the specific store.

18. The mobile take-out goods transaction method as claimed in claim 17, wherein the motor vehicle having said on-vehicle wireless ordering device installed therein further comprises a navigation system connected to said on-vehicle wireless ordering device; said customer service center server is capable of transmitting the information of the location of the searched specific store wirelessly to said motor vehicle during said step (b); the owner of the motor vehicle driving directly to the searched specific store subject to the guidance of said navigation system using the information of the location of the searched specific store as a destination location during said step (d).

19. The mobile take-out gods transaction method as claimed in claim 11, wherein said customer service center server transmits said order data to the specific store through a cable during said step (b).

20. The mobile take-out goods transaction method as claimed in claim 19, wherein said customer service center server transmits said order data to the specific store through a wired network.
